(19) United States
(12) Patent Application Publication
(10) Pub. No.: US 2019/0025648 A1
(43) Pub. Date: Jan. 24, 2019

(54) DISPLAY PANEL, DISPLAY SYSTEM, DISPLAY DEVICE AND DRIVING METHOD THEREOF

(71) Applicant: BOE TECHNOLOGY GROUP CO., LTD., Beijing (CN)

(72) Inventor: Chang Yen WU, Beijing (CN)

(21) Appl. No.: 15/756,379

(22) PCT Filed: Sep. 19, 2017
(86) PCT No.: PCT/CN2017/102267

§ 371 Date: Feb. 28, 2018

(30) Foreign Application Priority Data
Mar. 3, 2017 (CN) 201710125080.7

(51) Int. Cl. G02F 1/1335; G09G 3/20; G02B 27/01

(52) U.S. Cl. CPC G02F 1/133603; G09G 3/2074; G02B 2027/0178; G02B 27/017; G09G 3/2003

(57) ABSTRACT

A display panel, a display device, a display system and a driving method of the display device. The display panel includes a plurality of pixel units. Each of the plurality of the pixel units includes a first sub-pixel group and a second sub-pixel group, the first sub-pixel group is configured to display visible-light information, and the second sub-pixel group (13) is configured to display invisible-light information.

The present application claims priority to Chinese patent application No. 201710125080.7, filed on Mar. 3, 2017, the entire disclosure of which is incorporated herein by reference as part of the present application

### TECHNICAL FIELD

Embodiments of the present disclosure relate to a display panel, a display system, a display device and a driving method the display device.

### BACKGROUND

With the progress of display technology and the development of network technology, electronic devices, such as personal digital assistants, smart phones or table computers, are gradually popularized in daily life. More and more users use the electronic devices for performing transfer accounts, shopping and other operations, or use the electronic devices for displaying commercial and military information or transmiting confidential information through the Internet. When a user uses an electronic device to display information in a public place or transmit information through a network, in order to effectively prevent other people from maliciously stealing personal information, trade secrets or military secrets, etc., it is needed to display information in confidential manner (i.e., confidential display) through the electronic device to avoid leaking the personal information of the user, trade secrets or military secrets, etc.

Confidential display is divided into two main types: a glasses type and a naked-eye type. The naked-eye type of the confidential display is achieved by way of making the viewing angle small, so that people in a certain viewing angle range cannot see the displayed information, so as to achieve the confidential display, however, reducing the viewing angle also imposes some restrictions on the users when watching the displayed information, and the confidential display cannot be truly achieved. The glasses type of the confidential display is to display the confidential information by separating the confidential information through an external auxiliary device, and the confidential display can be truly achieved. Currently, the glasses type of the confidential display usually adopts similar 3D technologies, for example, to view the displayed information through polarized glasses, electronic shutter glasses, and the like. The polarized glasses use a polarized display technology, which will reduce half of the display brightness; the electronic shutter glasses use a time-sharing shading technology or a liquid crystal time-sharing technology to achieve the left and right frames alternately display in a frame sequence format, a left eye or a right eye of a user can only receive half the number of frames of information. Therefore, the glasses type of the confidential display will reduce the display brightness or reduce the numbers of frames, so as to affect the display effect and reduce display quality.

### SUMMARY

At least one embodiment of the present disclosure provides a display panel, a display device, a display system and a driving method of the display device. The display panel is provided with a first sub-pixel group and a second sub-pixel group, and displays visible-light information (such as, general information) through the first sub-pixel group and displays invisible-light information (such as, confidential information) through the second sub-pixel group, so that the same display panel can display two kinds of information, which are the general information and the confidential information, to achieve confidential information display. Meanwhile, the structure design of a pixel unit can achieve confidential display without limiting the viewing angle of the user, so as to enhance reading experience when the user watches the confidential information and improve the user's satisfaction. On the other hand, visible light emitted by the first sub-pixel group and invisible light emitted by the second sub-pixel group can be completely received by the user without reducing the display brightness and the number of frames of the information, so as to ameliorate the display effect of the confidential information and improve the display quality of confidential information.

At least one embodiment of the present disclosure provides a display panel, which comprises: a plurality of pixel units. Each of the plurality of the pixel units comprises a first sub-pixel group and a second sub-pixel group, the first sub-pixel group is configured to display visible-light information, and the second sub-pixel group is configured to display invisible-light information.

For example, in the display panel provided by an embodiment of the present disclosure, the first sub-pixel group comprises at least one red sub-pixel, at least one blue sub-pixel and at least one green sub-pixel.

For example, in the display panel provided by an embodiment of the present disclosure, the second sub-pixel group comprises at least one invisible sub-pixel.

For example, in the display panel provided by an embodiment of the present disclosure, the second sub-pixel group is configured to display information of invisible light having a wavelength range of 0.78 μm to 2.5 μm.

For example, in the display panel provided by an embodiment of the present disclosure, sub-pixels in the first sub-pixel group and sub-pixels in the second sub-pixel group are arranged alternately with each other.

For example, in the display panel provided by an embodiment of the present disclosure, the display panel is a liquid crystal display panel, the liquid crystal display panel comprises a backlight module, and the backlight module comprises a visible light source and an invisible light source.

For example, in the display panel provided by an embodiment of the present disclosure, the visible light source and the invisible light source both are light-emitting diodes.

For example, in the display panel provided by an embodiment of the present disclosure, the display panel is an organic light emitting diode (OLED) display panel, and a emitting layer of the second sub-pixel group is made of an invisible-light emitting material.

At least one embodiment of the present disclosure further provides a display device, which comprises any one of the above-mentioned display panel and a driving circuit. The driving circuit is configured to respectively provide driving signals to the first sub-pixel group and the second sub-pixel group of the display panel to drive the first sub-pixel group to display the visible-light information and drive the second sub-pixel group to display the invisible-light information respectively.

For example, in the display device provided by an embodiment of the present disclosure, the driving circuit comprises a first driving circuit and a second driving circuit. The first driving circuit is configured to drive the first sub-pixel group to display the visible-light information, and the second driving circuit is configured to drive the second sub-pixel group to display the invisible-light information.

At least one embodiment of the present disclosure further provides a display system, which comprises any one of the above-mentioned display device and glasses. The glasses are configured to transmit invisible light emitted by the second sub-pixel group of the display device.

At least one embodiment of the present disclosure further provides a driving method of any one of the above-mentioned display devices, and the driving method comprises: driving the first sub-pixel group and the second sub-pixel group in the display panel to respectively display the visible-light information and the invisible-light information.

For example, in the driving method provided by an embodiment of the present disclosure, the visible-light information and the invisible-light information are driven to display non-synchronously.

For example, in the driving method provided by an embodiment of the present disclosure, the display panel of the display device is a liquid crystal display panel, the liquid crystal display panel comprises a backlight module, the backlight module comprises a visible light source and an invisible light source, and the visible light source and the invisible light source are driven to emit light non-synchronously.

For example, in the driving method provided by an embodiment of the present disclosure, the second sub-pixel group is driven to display a black frame, while the visible-light information is displayed.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIG. 1a is a plane structure schematic diagram of a display panel provided by an embodiment of the present disclosure;

FIG. 1b is a plane structure schematic diagram of another display panel provided by an embodiment of the present disclosure;

FIG. 1c is a plane structure schematic diagram of yet another display panel provided by an embodiment of the present disclosure;

FIG. 1d is a plane structure schematic diagram of still another display panel provided by an embodiment of the present disclosure;

FIG. 2 is a plane structure schematic diagram of still yet another display panel provided by an embodiment of the present disclosure;

FIG. 3a is a schematic diagram of a display state of a display device provided by an embodiment of the present disclosure;

FIG. 3b is a schematic diagram of another display state of a display device provided by an embodiment of the present disclosure;

FIG. 4a is a schematic diagram of a display state of a display system provided by an embodiment of the present disclosure; and

FIG. 4b is a schematic diagram of another display state of a display system provided by an embodiment of the present disclosure.

### REFERENCE NUMERALS

100—display panel; 10—gate line; 11—data line; 12—first sub—pixel group; 120—red sub—pixel; 121—blue sub—pixel; 122—green sub—pixel; 13—second sub—pixel group; 14—thin film transistor; 15—switch transistor; 16—driving transistor; 17—storage capacitor; 18—power line; 20—glasses; 21—eyes; 30—invisible light; 31—visible light.

### DETAILED DESCRIPTION

In order to make objectives, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “include,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Each component or structure in the drawings is not drawn in strict accordance with the actual proportion, for clarity, the size of each component or structure may be exaggerated or reduced, such as increasing the thickness of the layer, the width of the electrode and etc., but these should not be used to limit the scope of the present disclosure.

At least one embodiment of the present disclosure provides a display panel, a display device, a display system and a driving method of the display device. The display panel comprises a plurality of pixel units, each of the plurality of the pixel units is provided with a first sub-pixel group and a second sub-pixel group, visible-light information (such as, general information) is displayed by the first sub-pixel group, and invisible-light information (such as, confidential information displayed by light invisible to the naked eye) is displayed by the second sub-pixel group, so that the display panel can display two kinds of information, which are the general information and the confidential information, to achieve confidential information display. On the other hand, the structure design of a pixel unit can achieve confidential display without limiting the viewing angle of the user, so as to enhance reading experience when the user watches the confidential information and improve the user's satisfaction. In yet another aspect, visible light emitted by the first sub-pixel group and light invisible to the naked eye emitted by the second sub-pixel group are completely received by the user without reducing the display brightness and the number of frames of the information, so as to ameliorate the display effect of the confidential information and improve the display quality of confidential information.

In the display device provided by the embodiment of the present disclosure, each of the plurality of pixel units in the display panel may emit the visible light by the first sub-pixel group and emit the invisible light by the second sub-pixel group. The general information carried by the visible light and the confidential information carried by the invisible light are provided for a user through the display device at the same time. For example, for other people (people who are not expected to see the confidential information), only the visible light provided by the first sub-pixel group can be received in a naked-eye state, so as to see the general information, and the invisible light cannot be received, so that the information, that is provided by the second sub-pixel group and is intended to be displayed confidentially, cannot be distinguished. However, a special observation device (such as glasses provided in the following embodiment of the present disclosure) can receive the invisible light provided by the second sub-pixel group and convert the invisible light into a form that is visible to human eyes, so that the user can use the special observation device to see the information that the user want to display confidentially. For example, the information displayed confidentially is a personal account password of the user, the trade secrets of a company, military secrets, and the like. The display device provided by an embodiment of the present disclosure and the corresponding display system can be anti-peep and display the information confidentially.

A few embodiments of the present disclosure are described in details below, but the present disclosure is not limited to these specific embodiments.

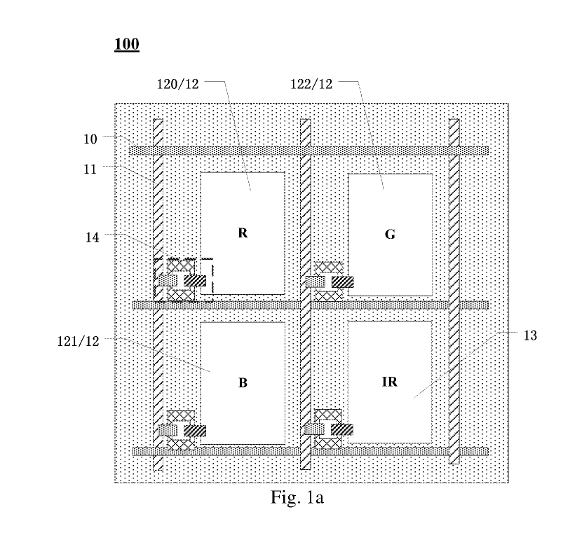

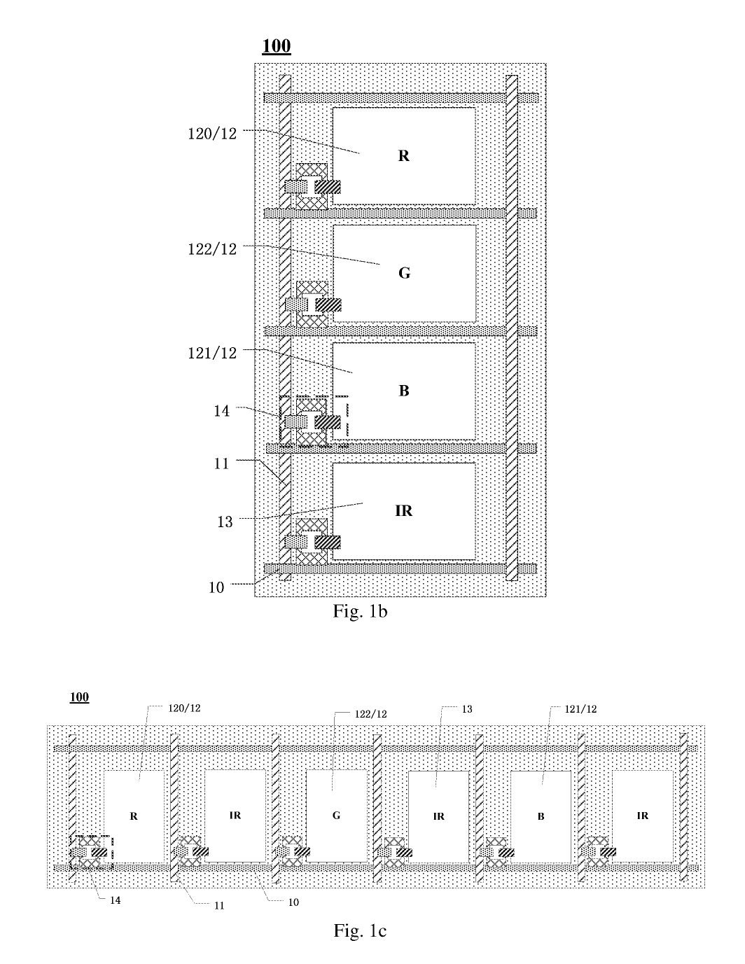

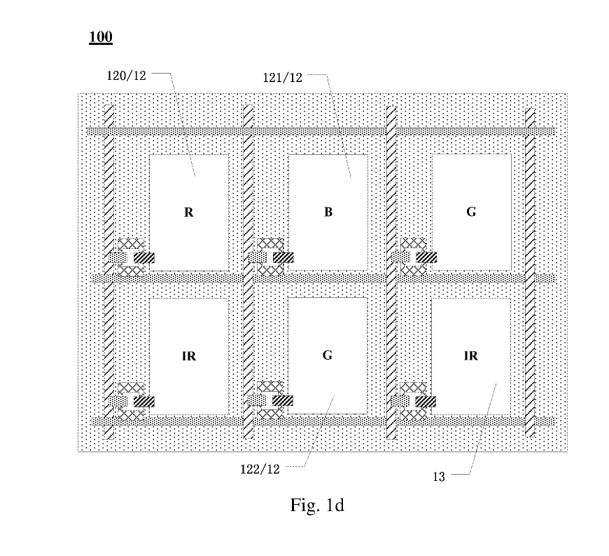

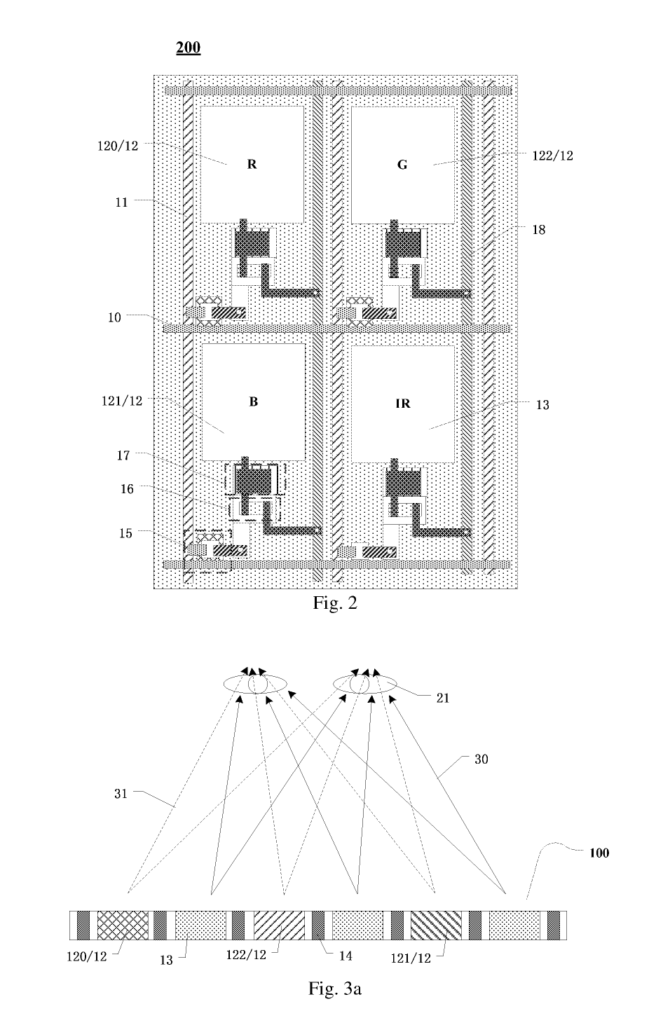

An embodiment of the present disclosure provides a display panel, FIG. 1a is a plane structure schematic diagram of a display panel provided by an embodiment of the present disclosure; FIG. 1b is a plane structure schematic diagram of another display panel provided by an embodiment of the present disclosure; FIG. 1c is a plane structure schematic diagram of yet another display panel provided by an embodiment of the present disclosure; FIG. 1d is a plane structure schematic diagram of still another display panel provided by an embodiment of the present disclosure; FIG. 2 is a plane structure schematic diagram of still yet another display panel provided by an embodiment of the present disclosure.

For example, as illustrated in FIG. 1a, a display panel 100 comprises a plurality of pixel units (not illustrated in FIG. 1a) disposed in areas defined by gate lines 10 and data lines 11 which are intersected with each other, and the plurality of pixel units are arranged in an array having a plurality of rows and a plurality of columns. Each of the plurality of the pixel units comprises a first sub-pixel group 12 and a second sub-pixel group 13, the first sub-pixel group 12 is configured to display visible-light information (such as general information), and the second sub-pixel group 13 is configured to display invisible-light information (such as confidential information), so that the pixel units can be used to display the general information and the confidential information. Because light used to display the confidential information is invisible light (the light that is invisible to the naked eye), other users (such as people who are not expected to see the confidential information) can only receive visible light in a naked-eye state, so as to see the general information; because other users cannot see the invisible light, they cannot receive content of the confidential information. However, a special observation device (such as glasses provided in the following embodiment of the present disclosure) can receive the invisible light and convert the invisible light into a form that is visible to human eyes, and the user may use the special observation device to see the content of the confidential information, so as to achieve confidential display.

For example, as illustrated in FIG. 1a, the first sub-pixel group 12 may comprise a red (R) sub-pixel 120, a blue (B) sub-pixel 121 and a green (G) sub-pixel 122, because a size of each sub-pixel is relatively small, and a plurality of sub-pixels may be visually mixed into the desired color to achieve colorful display. For another example, all the visible sub-pixels in the first sub-pixel group 12 may be monochrome visible light sub-pixels (for example, blue), so as to achieve monochrome or grayscale display.

It should be noted that, the first sub-pixel group 12 may comprise one or more visible light sub-pixels, and the one or more visible light sub-pixels may display different colors or the same color, so as to satisfy the requirements of display with different colors. In each pixel unit, the first sub-pixel group 12, for example, may comprise a plurality of red sub-pixels 120, a plurality of blue sub-pixels 121 or a plurality of green sub-pixels 122. In an example illustrated in FIG. 1d, the first sub-pixel group 12 of a pixel unit comprises one red sub-pixel 120, one blue sub-pixel 121 and two green sub-pixels 122, and the two green sub-pixels 122 are not located in a same row, and also are not located in a same column. For the human eye, green has a higher brightness stimulus value than red and blue, and has a relative great impact on the human eye resolution. In addition, visual acuity of the human visual system to brightness is much greater than visual acuity of the human visual system to color, so that the two green sub-pixels 122 are disposed in the first sub-pixel group 12, which does not greatly affect the resolution of the display panel 100 but can improve the display quality, and the user can more truly feel the information displayed on the display panel 100.

For example, the second sub-pixel group 13 may comprise an invisible light sub-pixel, and the invisible light sub-pixel may display infrared light information. For example, as illustrated in FIG. 1a, the invisible light sub-pixel may be an infrared (IR) sub-pixel, and a wavelength range of infrared light displayed by the infrared sub-pixel may be, for example, 0.78 μm-2.5 μm.

It should be noted that, the second sub-pixel group 13 may also comprise a plurality of invisible light sub-pixels, and the plurality of invisible light sub-pixels may display information of invisible light with the same wavelength or different wavelengths. For example, in an example illustrated in FIG. 1c, the second sub-pixel group 13 may comprise three infrared sub-pixels, which may display infrared light with the same wavelength (for example, a wavelength of 0.94 μm), and the three infrared sub-pixels can increase the brightness of confidential information display and improve the quality of confidential display. On the other hand, the three infrared sub-pixels may also display infrared light with wavelengths of 0.94 μm, 1.10 μm and 1.31 μm respectively, infrared light with different wavelengths can carry different confidential information, and the user can use special observation devices (such as glasses provided in the following embodiment of the present disclosure) to receive and convert the infrared light with different wavelengths to see different confidential information, so as to achieve multi-level confidential information display.

For example, the confidential information includes a personal account password of a user, a personal account, trade secrets of a company, military secrets, or the like.

It should be noted that, if the wavelength of the infrared light is about 0.85 μm, when watching the display panel at a close distance, the user can see that the infrared sub-pixel emits dark red light. Because the wavelength of the infrared light, which is 0.85 μm, is near the wavelength of a red light part of the visible light, thus the infrared sub-pixel may possibly produce a little visible light, so as to occur a slight red storm phenomenon. As a result, errors occur in the confidential display, and even the confidential information may be seen in the naked-eye state. In order to make the confidential information more concealed, clear and accurate, for example, infrared light with a wavelength of 0.94 μm can be used. For example, gallium arsenide light-emitting diodes may be used as the infrared light source, a peak wavelength range of the gallium arsenide light-emitting diodes is 0.94-0.95 μm, so that almost no visible light is produced and the red storm phenomenon will not occur, thereby improving accuracy and confidentiality of the confidential display.

For example, as illustrated in FIG. 1a-1d, the display panel 100 may be a liquid crystal display panel, the liquid crystal display panel comprises a backlight module, and the backlight module comprises a visible light source and an invisible light source. The visible light source may provide a backlight for the first sub-pixel group 12, and the invisible light source may provide a backlight for the second sub-pixel group 13. In the first sub-pixel group 12, the red sub-pixel 120, the green sub-pixel 122 and the blue sub-pixel 121 may be formed by using, for example, a red color filter, a green color filter and a blue color filter respectively, that is, when white light passes through these color filters, red light, green light and blue light are generated respectively.

For example, the visible light source and the invisible light source may be both light emitting diodes (LEDs), point light sources, linear light sources (cold cathode fluorescent lamps CCFL or hot cathode fluorescent lamps HCFL), planar light sources VFD (flat fluorescent lamps), electroluminescent (EL) layer, or the like.

For example, the visible light source may emit the white light, and the invisible light source may emit the infrared light. For example, an IR cut-off filter (IRCF) may be additionally disposed in each visible sub-pixel of the first sub-pixel group 12 (although for example, the color filter can also play a role of filtering out at least part of the infrared light), so as to filter out infrared light of a specific wavelength range in the white light (such as, the specific wavelength range is a wavelength range of infrared light emitted by the invisible light source). In this way, when the display panel 100 displays the confidential information through the second sub-pixel group 13, the display panel 100 can obtain clear and complete confidential information without being affected by the white light source so as to reduce or eliminate the erroneous confidential information displayed due to the infrared light in the white light source. It should be noted that, when the invisible light source emits other invisible light, a corresponding invisible light cut-off filter may be disposed in the first sub-pixel group 12 to eliminate the influence of the white light source on the confidential information. The embodiments of the present disclosure do not limited thereto.

For example, as illustrated in FIG. 2, the display panel 100 may be an organic light emitting diode (OLED) display panel. Light emitting layers in the first sub-pixel group 12 and the second sub-pixel group 13 can emit light by electroluminescence. A material for forming the light-emitting layer of the OLED display panel may be selected according to different light-emitting wavelength. For example, the light-emitting layer of the first sub-pixel group 12 is made of a visible-light emitting material, and the light-emitting layer of the second sub-pixel group 13 is made of an invisible-light emitting material.

For example, the first sub-pixel group 12 may comprise at least one visible light sub-pixel, and a light-emitting layer of the at least one visible light sub-pixel may be made of a visible-light emitting material that emits light of the same color, or also may be made of visible-light emitting materials that emit light of different colors. For example, the first sub-pixel group 12 may comprise three visible sub-pixels, and emit the red light, the green light and the blue light respectively. The second sub-pixel group 13 may comprise at least one invisible light sub-pixel, and a light-emitting layer of the at least one invisible light sub-pixel may be made of an invisible-light emitting material that emits light with the same wavelength, or also may be made of invisible-light emitting materials that emit light with different wavelengths. For example, the second sub-pixel group 13 may comprise one invisible light sub-pixel, and may emit the infrared light with a wavelength of 0.94 μm.

For example, the visible-light emitting material may include a fluorescence light emitting material, a phosphorescence light emitting material, a scintillation material, or the like. A doping system may be used, that is, a doping material is mixed into a host light emitting material to obtain the visible-light emitting material. For example, the host light emitting material may be a metal compound material, an anthracene derivative, an aromatic diamine compound, a triphenyl amine compound, an aromatic triamine compound, a biphenylenediamine derivative, a triarylamine polymer, or the like.

For example, the invisible-light emitting material may include a germanate infrared-light emitting material, a rare-earth element complex, an organic polymer, an organic ion dye, or the like. For example, a third-order rare-earth erbium ion (Er³⁺) complex has luminescent properties in a near infrared region, and can react with the ligands of the cyclic organic substance to generate a series of rare-earth organic complexes that can emit the infrared light. For example, a peak wavelength of fluorescence emission of an Er(BMA)₃ (Phen) complex with Phen (1,10-phenanthroline) and BMA (butyl methacrylate) as organic ligands is 1.536 μm.

For example, in the OLED display panel, the first sub-pixel group 12 may comprise at least one red sub-pixel 120, at least one blue sub-pixel 121, and at least one green sub-pixel 122. For example, in an example, each pixel unit may be provided with one red sub-pixel 120, one blue sub-pixel 121, and one green sub-pixel 122. Because in the OLED display panel, the brightness of the blue sub-pixel 121 decays rapidly with time, the brightness of the green sub-pixel 122 and the red sub-pixel 120 decays slowly with time. As a result, with the use of the OLED display panel, the color coordinates of light drift and red shift phenomenon appears in white balance, that is, when displaying full-color, white balance shifts to warm, so as to seriously affect the life of the OLED display panel and display effect of the image. However, a plurality of (for example, two) blue sub-pixels 121 are disposed in one pixel unit, which can increase a light-emitting area of the blue sub-pixels 121 in one pixel unit, so as to ameliorate the phenomenon of white balance shifting to warm, optimize the display effect of the image, and prolong the life of the OLED display panel.

It should be noted that, the visible light sub-pixel is not limited to the red sub-pixel, the green sub-pixel and the blue sub-pixel. The invisible light sub-pixel is also not limited to the infrared sub-pixel. The number of and colors of the sub-pixels in respective the first sub-pixel group 12 and the second sub-pixel group 13 may be designed according to actual needs, which is not limited in the embodiment of the present disclosure.

For example, as illustrated in FIG. 1a to FIG. 2, the plurality of visible light sub-pixels in the first sub-pixel group 12 may be arranged in the same row or in the same column, or may also be arranged in a “A” triangle manner. The plurality of invisible light sub-pixels in the second sub-pixel group 13 may be arranged in the same row or in the same column, or may also be arranged in a “A” triangle manner. For another example, the plurality of visible light sub-pixels in the first sub-pixel group 12 and the plurality of invisible light sub-pixels in the second sub-pixel group 13 may be arranged alternately with each other. Because the size of the pixel unit is small, the display effect is not affected even if the invisible light sub-pixels and the visible light sub-pixels are arranged alternately with each other. The first sub-pixel group 12 and the second sub-pixel group 13 may also be arranged adjacent to each other, and the plurality of visible light sub-pixels are successively arranged adjacent to each other, and the plurality of invisible light sub-pixels are successively arranged adjacent to each other. The embodiments of the present disclosure do not limit the arrangement of the sub-pixels in respective the first sub-pixel group 12 and the second sub-pixel group 13

An embodiment of the present disclosure further provides a display device, which comprises the display panel 100 described above and a driving circuit (such as, an integrated circuit chip). The driving circuit is configured to respectively provide driving signals to the first sub-pixel group 12 and the second sub-pixel group 13 of the display panel 100 to drive the first sub-pixel group 12 to display the visible-light information and the second sub-pixel group 13 to display the invisible-light information respectively.

The display panel 100 provided by the present disclosure may be applied to various types of display panels.

For example, in an example, the display panel 100 is a liquid crystal display panel. As illustrated in FIGS. 1a-1d, the driving circuit may comprise a thin film transistor 14. A gate electrode of the thin film transistor 14 is connected to a gate line 10, a drain electrode (or a source electrode) is connected to a data line 11, and accordingly the source electrode (or the drain electrode) is connected to a sub-pixel of a pixel unit on the liquid crystal display panel, so that the thin film transistors 14 may act as a signal read switch of the first sub-pixel group 12 and the second sub-pixel group 13. For example, when a turn-on signal is applied to the gate line 10, the thin film transistor 14 is turned on, so that a data signal applied on the data line 11 can be transmitted to a pixel electrode of the pixel unit on the liquid crystal display panel. When a turn-off signal is applied to the gate line 10, the thin film transistor 14 is turned off, charges stored on the pixel electrode continues to maintain a voltage on the pixel electrode of the pixel unit, so that the liquid crystal display panel can steadily display. Thus, during a whole frame period, the driving circuit may drive the first sub-pixel group 12 to display the visible-light information and drive the second sub-pixel group 13 to display the invisible-light information.

For example, in another example, the display panel 100 is an OLED display panel. As illustrated in FIG. 2, the driving circuit comprises a switch transistor 15, a driving transistor 16 and a storage capacitor 17, that is, the driving circuit can have, for example, a 2T1C structure. In a case that the turn-on signal is applied to the gate line 10, the switch transistor 15 is turned on and the data signal is transmitted to the gate electrode of the driving transistor 16 to turn on the driving transistor 16, the current on the power line 18 flows through the driving transistor 16, and then flows to the sub-pixels of the pixel units in the OLED display panel; in a case that the turn-off signal is applied to the gate line 10, the switch transistor 15 is turned off, the charges stored in the storage capacitor 17 continues to maintain the gate voltage of the driving transistor 16, the driving transistor 16 is still turned on, so that the OLED display panel can steadily display. Thus, during a whole frame period, the driving circuit may drive the first sub-pixel group 12 to display the visible-light information and drive the second sub-pixel group 13 to display the invisible-light information.

It should be noted that, the driving circuit may also have structures such as 3T1C, 4T1C. For example, the driving circuit may further comprise a detection transistor, a compensation transistor, a reset transistor, and the like. The embodiments of the present disclosure do not limited the specific structure of the driving circuit.

For example, the driving circuit may comprise a first driving circuit and a second driving circuit. The first driving circuit is configured to drive the first sub-pixel group 12 to display the visible-light information, and the second driving circuit is configured to drive the second sub-pixel group 13 to display the invisible-light information. For example, the first driving circuit and the second driving circuit may drive the first sub-pixel group 12 and the second sub-pixel group 13 to display the information synchronously or non-synchronously. For example, in the first sub-pixel group 12, each visible sub-pixel may be provided with a corresponding first driving circuit, and in the second sub-pixel group 13, each invisible sub-pixel may also be provided with a corresponding second driving circuit, so that respective sub-pixels in the first sub-pixel group 12 and the second sub-pixel group 13 can be separately controlled to drive the respective sub-pixels to display the information synchronously or non-synchronously. For example, respective visible sub-pixels in the first sub-pixel group 12 may be driven synchronously to display the general information, and respective invisible sub-pixels in the second sub-pixel group 13 may be driven synchronously to display the confidential information.

It should be noted that, the display device provided by the embodiments of the present disclosure may be a mobile phone, a tablet computer, a television, a monitor, a laptop computer, a digital photo frame, a navigator, or any products or components having any display function.

An embodiment of the present disclosure further provides a display system, which comprises any one of the above-mentioned display device and glasses. The glasses are configured to transmit invisible light emitted by the second sub-pixel group of the display panel in the display device, but do not transmit visible light emitted by the first sub-pixel group. For example, when the invisible light is infrared light, lens of the glasses may be provided with an infrared filter, an infrared image sensor (such as a charge-coupled device CCD or a complementary metal-oxide semiconductor COMS), a display circuit, and the like, so that the infrared light can be transmitted through the infrared filter, and then is converted into an image visible to eyes via the infrared image sensor and the display circuit, finally is observed by eyes of an user. Thus, the user may receive the confidential information displayed by the infrared light. In addition, the visible light cannot be transmitted through the infrared filter to enter the eyes of the user, and does not interfere with the confidential information.

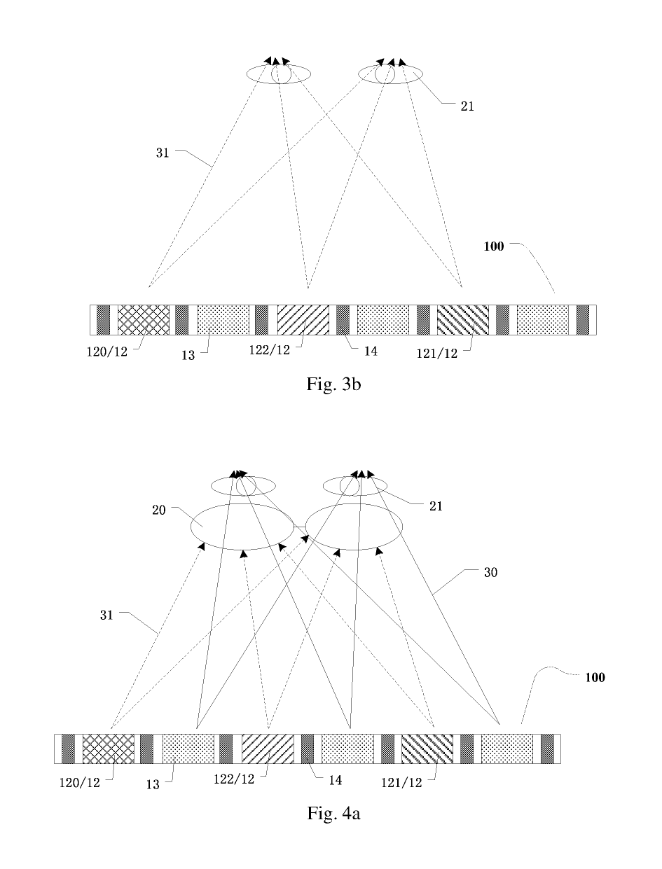

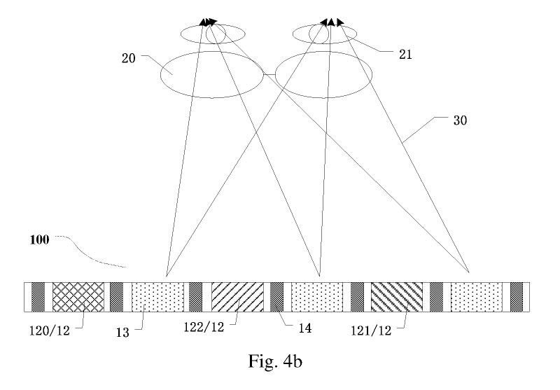

FIG. 3a is a schematic diagram of a display state of a display device provided by an embodiment of the present disclosure; FIG. 3b is a schematic diagram of another display state of a display device provided by an embodiment of the present disclosure; FIG. 4a is a schematic diagram of a display state of a display system provided by an embodiment of the present disclosure; and FIG. 4b is a schematic diagram of another display state of a display system provided by an embodiment of the present disclosure.

In order to more specifically explain a working principle of the display device provided by the embodiments of the present disclosure in a display system, in an example of the embodiment of the present disclosure, a structure of the pixel unit illustrated in FIG. 1c is selected to be described. As illustrated in FIG. 1c, a pixel unit is composed of a first sub-pixel group 12 and a second sub-pixel group 13. The first sub-pixel group 12 comprises a red sub-pixel 120, a blue sub-pixel 121 and a green sub-pixel 122. The second sub-pixel group 13 comprises three infrared sub-pixels. Respective sub-pixels in the first sub-pixel group 12 and the second sub-pixel group 13 are arranged in a same row.

For example, as illustrated in FIGS. 3a and 4a, the first driving circuit and the second driving circuit may synchronously drive the first sub-pixel group 12 and the second sub-pixel group 13 to emit visible light 31 and invisible light 30 respectively. In a case that a user is in a naked-eye state, eyes 21 can only receive the visible light 31, so as to see the general information. The user cannot receive the invisible light 30, and cannot distinguish the information that is provided by the second sub-pixel group 12 and desired to be displayed confidentially. While the user wearing the glasses 20 can receive the invisible light 30 emitted by the second sub-pixel group 13 to see the confidential information. Therefore, the display system can prevent a person who does not wear the glasses 20 from peeping.

For example, as illustrated in FIG. 3b, the first driving circuit may drive the first sub-pixel group 12 to emit the visible light 31 individually. When the user is in the naked-eye state, the eyes 21 can receive the visible light 31, so as to see the general information. Because no display signals or only signals for displaying a black frame are inputted to the second sub-pixel group 13, the second sub-pixel group 13 does not display a message. The user wearing the glasses 20 can only see that a display screen of the display panel 100 is a black screen, so that the user wearing the glasses 20 can know that the display panel 100 does not display the confidential information. As illustrated in FIG. 4b, the second driving circuit may drive the second sub-pixel group 13 to emit the invisible light 30 individually. The user wearing the glasses 20 can receive the invisible light 30 emitted by the second sub-pixel group 13, so as to see the confidential information. Because the display signals or only signals for displaying a black frame are inputted to the first sub-pixel group 12, the user in the naked-eye state can only see that the display screen of the display panel 100 is a normal black screen, and cannot obtain the confidential information, so as to prevent a person who do not wear the glasses 20 from peeping.

It should be noted that, a chip of the display device may be provided with a corresponding control circuit or program, and the user may turn on or off the first driving circuit or the second driving circuit by clicking a corresponding function key or icon on the display device. Alternatively, the display device also may be provided with a corresponding switch button, and the user may turn on or off the first driving circuit or the second driving circuit by touching, pressing, screwing, pulling the corresponding switch button, or the like. In this way, the display device can freely switch between two display modes that area confidential display mode and a general display mode. The embodiments of the present disclosure do not specifically limit an approach of switching between the confidential display mode and the general display mode.

An embodiment of the present disclosure further provides a driving method for driving any one of the above-mentioned display devices, and the driving method comprises: driving the first sub-pixel group and the second sub-pixel group in the display panel to respectively display the visible-light information and the invisible-light information.

For example, in the driving method provided by the embodiment of the present disclosure, respective sub-pixels of the first sub-pixel group and the second sub-pixel group may be driven by a first driving circuit connected to the first sub-pixel group and a second driving circuit connected to the second sub-pixel group respectively. For example, the first driving circuit may drive the first sub-pixel group in the display panel to display the visible-light information, and the second driving circuit may drive the second sub-pixel group in the display panel to display the invisible-light information.

For example, the visible-light information and the invisible-light information may be the same or different. If the visible-light information and the invisible-light information are different from each other, the visible-light information, for instance, may be the general information, and the invisible-light information, for instance, may be the confidential information.

For example, the visible-light information and the invisible-light information may be driven to display non-synchronously, or also may be driven to display synchronously. When the visible-light information and the invisible-light information are driven to display synchronously, the display panel can display two kinds of information at the same time, so as to display different information for different people. For example, the user in the naked-eye state can see only the visible-light information displayed by the first sib-pixel group, and the user wearing the glasses can see the invisible-light information displayed by the second sub-pixel group, so as to achieve the information confidential display. When the visible-light information and the invisible-light information are driven to display non-synchronously, the display panel can separately display the visible-light information or the invisible-pixel information. For example, in a case that a visible light source is a white light source or a visible-light emitting material that emits white light, the second driving circuit may be used to drive the second sub-pixel group individually to display the confidential information, so as to eliminate the interference of the invisible light in the white light source with the confidential information displayed by the display panel.

For example, in an example, the display panel of the display device is a liquid crystal display panel, the liquid crystal display panel comprises a backlight module, and the backlight module comprises a visible light source and an invisible light source. The visible light source and the invisible light source are driven to emit light non-synchronously or synchronously. For example, the visible-light information and the invisible-light information may be displayed non-synchronously, and frames of the visible-light information and frames of the invisible-light information may be displayed alternately. In a case that a frame of the visible-light information is displayed, the visible light source is turned on, but the invisible light source is turned off; in a case that a frame of the invisible-light information is displayed, the invisible light source is turned on, but the visible light source is turned off. For example, during a period of displaying the frame of the visible-light information, a black frame data signal may be applied to the second sub-pixel group, so that the second sub-pixel group does not transmit light (including the visible light and the invisible light). Therefore, the second sub-pixel group displays a black frame, so as to eliminate the influence of the invisible light from the backlight module on the visible-light information. As for the visible-light information, the black frame inserted between the adjacent frames does not affect the display effect, and may have the effect of reducing crosstalk between frames. Similarly, during a period of displaying the frame of the invisible-light information, the black frame data signal is applied to the first sub-pixel group, so that the first sub-pixel group does not transmit light and displays a black frame.

For example, in another example, the display panel of the display panel is an OLED display panel, light-emitting layers of the first sub-pixel group and the second sub-pixel group may be driven to emit light synchronously or non-synchronously. For example, frames of the visible-light information and frames of the invisible-light information may be alternately displayed to achieve non-synchronous display, when the frames of the visible light information is displayed, the light-emitting layer in the first sub-pixel groupis driven to emit light by the first driving circuit, while the light-emitting layer in the second sub-pixel group does not emit light; when the frame of the invisible-light information is displayed, the light-emitting layer in the second sub-pixel group is driven to emit light by the second driving circuit, while the light-emitting layer in the first sub-pixel group does not emit light.

For the present disclosure, the following statements should be noted:
(1) the accompanying drawings involve only the structure(s) in connection with the embodiment(s) of the present disclosure, and other structure(s) can be referred to in common design(s);
(2) for the purpose of clarity only, in accompanying drawings for illustrating the embodiment(s) of the present disclosure, the thickness a layer or area may be enlarged or narrowed, that is, the drawings are not drawn in a real scale.
(3) in case of no conflict, the embodiments of the present disclosure and the features in the embodiment(s) can be combined with each other to obtain new embodiment(s).

What have been described above are only specific implementations of the present disclosure, the protection scope of the present disclosure is not limited thereto, and the protection scope of the present disclosure should be based on the protection scope of the claims.

1. A display panel, comprising:
a plurality of pixel units, each of the plurality of the pixel units comprising a first sub-pixel group and a second sub-pixel group,
wherein the first sub-pixel group is configured to display visible-light information, and the second sub-pixel group is configured to display invisible-light information.

2. The display panel according to claim 1, wherein the first sub-pixel group comprises at least one red sub-pixel, at least one blue sub-pixel and at least one green sub-pixel.

3. The display panel according to claim 1, wherein the second sub-pixel group comprises at least one invisible sub-pixel.

4. The display panel according to claim 1, wherein the second sub-pixel group is configured to display information of invisible light having a wavelength range of 0.78 μm to 2.5 μm.

5. The display panel according to claim 1, wherein sub-pixels in the first sub-pixel group and sub-pixels in the second sub-pixel group are arranged alternately with each other.

6. The display panel according to claim 1, wherein the display panel is a liquid crystal display panel, the liquid crystal display panel comprises a backlight module, and the backlight module comprises a visible light source and an invisible light source.

7. The display panel according to claim 6, wherein the visible light source and the invisible light source both are light-emitting diodes.

8. The display panel according to claim 1, wherein the display panel is an organic light emitting diode display panel, and a light-emitting layer of the second sub-pixel group is made of an invisible-light light-emitting material.

9. A display device, comprising:
a display panel according to claim 1;
a driving circuit;
wherein the driving circuit is configured to provide driving signals for the display panel to drive the first sub-pixel group to display the visible-light information and drive the second sub-pixel group to display the invisible-light information respectively.

10. The display device according to claim 9, wherein the driving circuit comprises a first driving circuit and a second driving circuit, the first driving circuit is configured to drive the first sub-pixel group to display the visible-light information, and the second driving circuit is configured to drive the second sub-pixel group to display the invisible-light information.

11. A display system, comprising:
a display device according to claim 9;
glasses;
wherein the glasses are configured to transmit invisible light emitted by the second sub-pixel group of the display device.

12. A driving method of a display device according to claim 9, comprising:
driving the first sub-pixel group and the second sub-pixel group in the display panel to respectively display the visible-light information and the invisible-light information.

13. The driving method according to claim 12, wherein the visible-light information and the invisible-light information are driven to display non-synchronously.

14. The driving method according to claim 13, wherein the display panel of the display device is a liquid crystal display panel, the liquid crystal display panel comprises a backlight module, the backlight module comprises a visible light source and an invisible light source, and the visible light source and the invisible light source are driven to emit light non-synchronously.

15. The driving method according to claim 13, wherein the second sub-pixel group is driven to display a black frame, while the visible-light information is displayed.
